(19) United States
(12) Patent Application Publication
(10) Pub. No.: US 2003/0042864 A1
(43) Pub. Date: Mar. 6, 2003

(54) Switched-reluctance motor control

(75) Inventors: Bruno P.B. Lequesne, Troy, MI (US); Avoki M. Omekanda, Rochester, MI (US); Syed A. Hossain, Akron, OH (US); Harald Klode, Centerville, OH (US); Jin-Jae Chen, Gahanna, OH (US)

Correspondence Address: DELPHI TECHNOLOGIES, INC., Legal Staff, Mail Code: 482-204-450, 1450 W. Long Lakem, P.O. BOX 5052, Troy, MI, 48098, US

(73) Assignee: DELPHI TECHNOLOGIES, INC.

(21) Appl. No.: 09/943,961

(22) Filed: Aug. 31, 2001

(51) Int. Cl. H02P 1/46; H02P 3/18; H02P 5/28; H02P 7/36

(52) U.S. Cl. 318/701

(57) ABSTRACT

A device for implementing a method for controlling a switched-reluctance motor having a rotor and excitable phases is disclosed. The device comprises a controller and an interface for implementing a master control routine including a pre-alignment stage, a preliminary stage, and a primary stage. During the pre-alignment stage, the rotor is rotated to an initial position corresponding to one the phases being aligned. During the preliminary stage, the rotor is rotated from the initial position is rotated in a desired direction. During the primary stage, any operational losses are minimized when the rotor is positioned in a holding position.

### BACKGROUND OF THE INVENTION

1. Field of the Invention

The present invention generally relates to a control of a switched-reluctance motor. The present invention specifically relates to a brake-by-wire system having a switched-reluctance motor that is controlled during a pre-alignment braking phase, a preliminary braking phase, and a primary braking phase.

2. Description of the Related Art

Switched-reluctance motors are emerging as a prime candidate for various applications (e.g., automotive brake applications), because switched-reluctance motors provide an advantage of a large peak-torque capability on an intermittent basis and an advantage of a large speed range. Additionally, switched-reluctance motors have inherent fault tolerant features.

A switched-reluctance motor operates on the principle of variable reluctance, and typically includes a stator pole, a plurality of windings, and a rotor, such as a stator 20, windings 31-38, and a rotor 40 forming a 4-phase, 8 stator pole/6 rotor pole switched-reluctance motor as shown in FIGS. 1A-1D. Stator 20 includes stator poles 21-28, and rotor 40 includes rotor poles 41-46. Windings 31-38 are wrapped around stator poles 21-28, respectively.

Winding 31 and winding 35 are electrically coupled (not shown) to define a phase A of the motor whereby a phase current flowing through winding 31 and winding 35 generates diametric magnetic fields around stator pole 21 and stator pole 25. Winding 32 and winding 36 are electrically coupled (not shown) to define a phase B of the motor whereby a phase current flowing through winding 32 and winding 36 generates diametric magnetic fields around stator pole 22 and stator pole 26. Winding 33 and winding 37 are electrically coupled (not shown) to define a phase C of the motor whereby a phase current flowing through winding 33 and winding 37 generates diametric magnetic fields around stator pole 23 and stator pole 27. Winding 34 and winding 38 are electrically coupled (not shown) to define a phase D of the motor whereby a phase current flowing through winding 34 and winding 38 generates diametric magnetic fields around stator pole 24 and stator pole 28.

Rotor 40 is typically made of iron, and as a result, rotor 40 can be rotated about an axis 40a in response to a generation of one or more pairs of diametric magnetic fields. Phase currents are therefore strategically provided to windings 31-38 to thereby rotate rotor 40 about axis 40a in a clockwise direction or in a counterclockwise direction. Stator 20, windings 31-38, and rotor 40 are housed within a system (e.g., a electrically-actuated brake system) with the rotor 40 being coupled to an actuating member (e.g., a planetary gear assembly) of the system whereby the actuating member concurrently rotates about axis 40a in response to any rotation of rotor 40 about axis 40a.

Various complicated phase current control schemes have been devised for determining a rotational position of rotor 40, for rotating rotor 40 over a large speed range, for avoiding local overheating of the switched-reluctance motor, and for minimizing the ampere levels of the phase currents. The present invention addresses a need for a simplified phase current control scheme for comprehensively controlling a positioning and a rotation of rotor 40 about axis 40a.

### SUMMARY OF THE INVENTION

One form of the present invention is method of controlling an operation of a switched-reluctance motor including a stator having a stator pole and a rotor having a rotor pole. First, the rotor pole and the stator pole are aligned in response to a reception of an actuation command. Second, the rotor is cranked in a direction dictated by the actuation command for a predetermined time period. Third, the rotor is rotated to a holding position upon an expiration of the predetermined time period. Finally, any operational losses of the switched-reluctance motor are minimized when the rotor is in the holding position.

A second form of the present invention is a device for controlling an operation of a switched-reluctance motor including a stator having a stator pole and a rotor having a rotor pole. The system comprises the following means. A means for aligning the rotor pole and the stator pole in response to a reception of an actuation command. A means for cranking the rotor in a direction dictated by the actuation command for a predetermined time period. A means for rotating the rotor to a holding position upon an expiration of the predetermined time period. And, a means for minimizing any operational losses of the switched-reluctance motor when the rotor is in the holding position.

A third form of the present invention is a switched-reluctance motor including a stator having a stator pole, and a rotor having a rotor pole. The switched-reluctance motor further comprises the following means. A means for aligning the rotor pole and the stator pole in response to a reception of an actuation command. A means for cranking the rotor in a direction dictated by the actuation command for a predetermined time period. A means for rotating the rotor to a holding position upon an expiration of the predetermined time period. And, a means for minimizing any operational losses of the switched-reluctance motor when the rotor is in the holding position.

The foregoing forms, and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1A is a diagrammatic cross-sectional view of a stator pole, windings, and a rotor of a prior art 4-phase, 8 stator pole/6 rotor pole switched-reluctance motor with phase A aligned;

FIG. 1B is a diagrammatic cross-sectional view of a stator pole, windings, and a rotor of a prior art 4-phase, 8-stator pole/6 rotor pole switched-reluctance motor with phase B aligned;

FIG. 1C is a diagrammatic cross-sectional view of a stator pole, windings, and a rotor of a prior art 4-phase, 8-stator pole/6 rotor pole switched-reluctance motor with phase C aligned;

FIG. 1D is a diagrammatic cross-sectional view of a stator pole, windings, and a rotor of a prior art 4-phase, 8-stator pole/6 rotor pole switched-reluctance motor with phase D aligned;

FIG. 2 is block diagram of one embodiment of a control device of the present invention;

FIG. 3 is flow chart of one embodiment of a master control routine implemented by the FIG. 2 control device;

FIG. 4A is flow chart of a first embodiment of a pre-alignment control routine implemented by the FIG. 2 control device;

FIG. 4B illustrates exemplary graphs of phase currents employed during an implementation of the FIG. 4A pre-alignment control routine;

FIG. 5A is flow chart of a second embodiment of a pre-alignment control routine implemented by the FIG. 2 control device;

FIG. 5B is a first exemplary graph of a torque characteristic of the rotor of the FIG. 1 switched-reluctance motor versus a rotational position of the rotor;

FIG. 5C illustrates exemplary graphs of phase currents employed during an implementation of the FIG. 5A pre-alignment control;

FIG. 6A is flow chart of one embodiment of a preliminary control routine implemented by the FIG. 2 control device;

FIG. 6B illustrates exemplary graphs of phase currents employed during an implementation of the FIG. 6A preliminary control routine;

FIG. 7A is flow chart of one embodiment of a primary control routine implemented by the FIG. 2 control device;

FIG. 7B illustrates exemplary graphs of phase currents employed during an implementation of the FIG. 7A primary control routine;

FIG. 8A is flow chart of a second embodiment of primary control routine implemented by the FIG. 2 control device;

FIG. 8B is a second exemplary graph of a torque characteristic of the rotor of the FIG. 1 switched-reluctance motor versus a rotational position of the rotor; and

FIG. 8C illustrates an exemplary graph of a phase current employed during an implementation of the FIG. 8A primary control routine.

### DETAILED DESCRIPTION OF THE PRESENTLY PREFERRED EMBODIMENTS

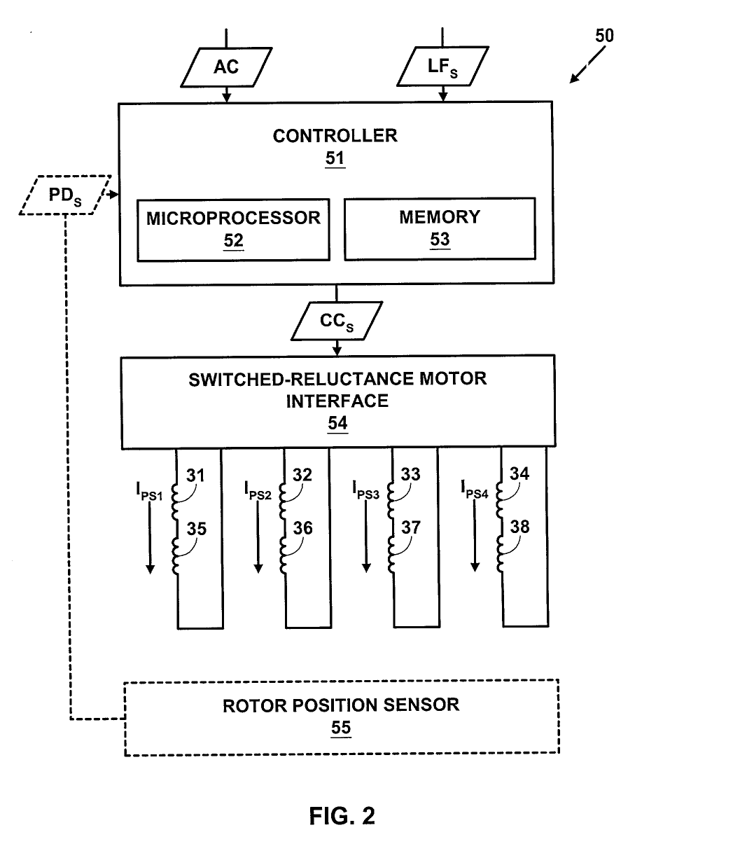

A control device 50 of the present invention is shown in FIG. 2. Control device 50 comprises a controller 51 and a switched-reluctance motor interface 54. Control device 50 optionally comprises a rotor position sensor 55.

Controller 51 is preferably an electronic circuit comprised of one or more components that are assembled as a common unit within a system (e.g., a electrically-actuated brake system). Alternatively, for the multiple component embodiments, one or more of these components may be distributed throughout the system housing controller 51. Controller 51 may be comprised of digital circuitry, analog circuitry, or both. Also, controller 51 may be programmable, a dedicated state machine, or a hybrid combination of programmable and dedicated hardware. To implement the principles of the present invention, controller 51 can further include any control clocks, interfaces, signal conditioners, filters, Analog-to-Digital (A/D) converters, Digital-to-Analog (D/A) converters, communication ports, or other types of operators as would occur to those having ordinary skill in the art.

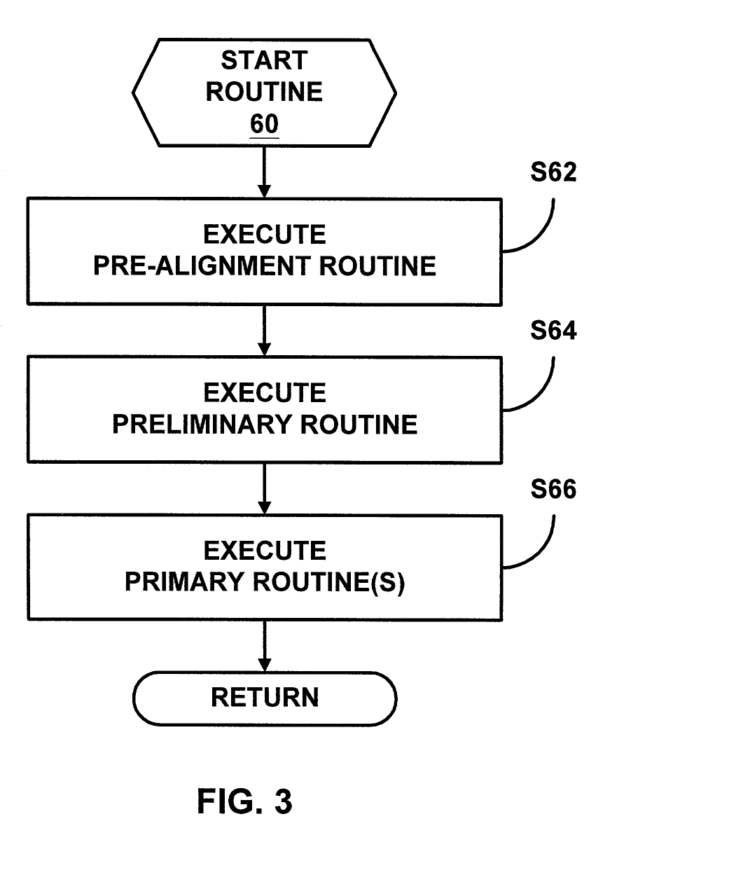

In one embodiment, controller 51 includes a microprocessor 52 operatively coupled to one or more solid-state memory devices 53. Microprocessor 52 is preferably a microprocessor from one the Intel, AMD, or Motorola families of microprocessors. Memory 53 is one or more computer readable mediums (e.g., a read-only memory, an erasable read-only memory, a random access memory, a compact disk, a floppy disk, a hard disk drive, and other known forms) that are electrically, magnetically, optically or chemically altered to contain computer readable code corresponding to a master control routine 60 (FIG. 3) for intelligently providing a commutation control signal CCₛ to interface 54, and is arranged for reading and writing of data in accordance with the principles of the present invention. In alternative embodiments of controller 51, the computer program product corresponding to master control routine 60 (FIG. 3) can otherwise be partially or fully implemented by digital circuitry, analog circuitry, or both (e.g., an application specific integrated circuit (ASIC))

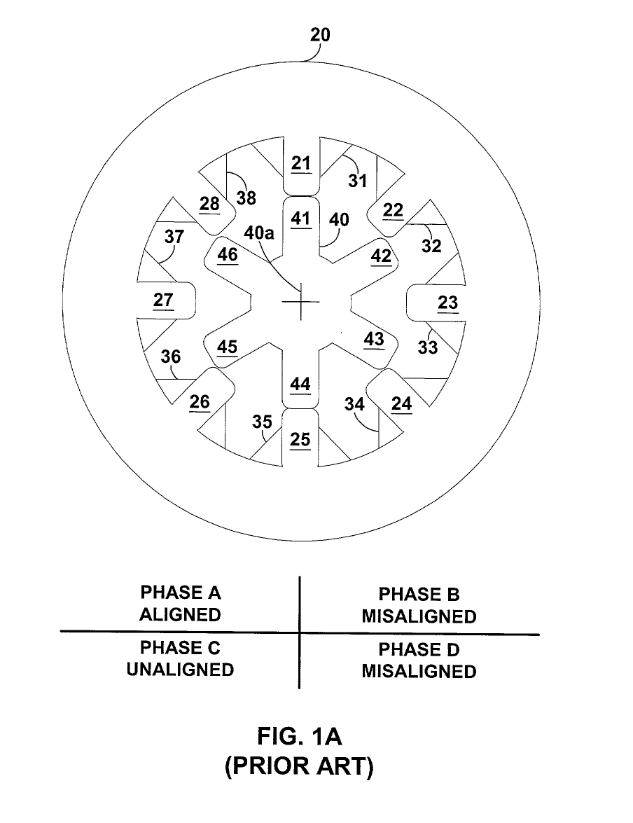

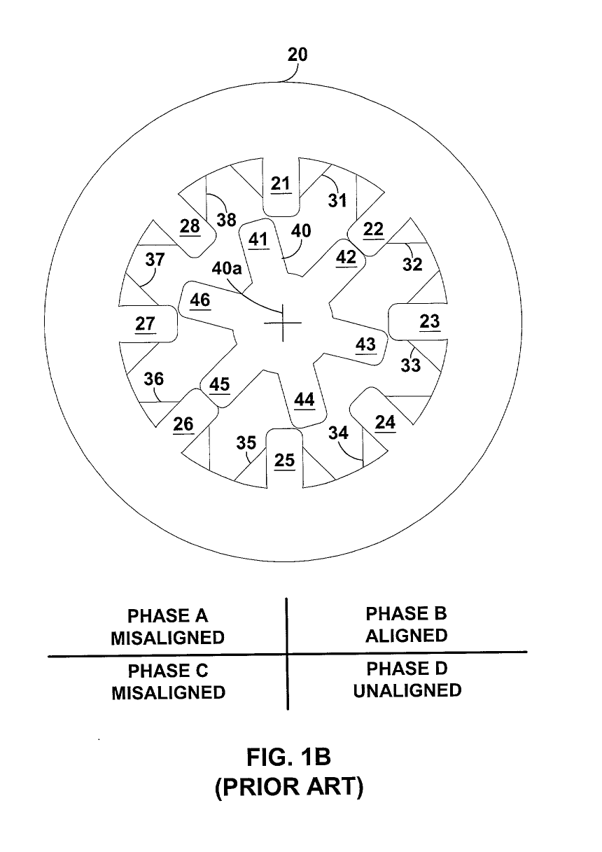

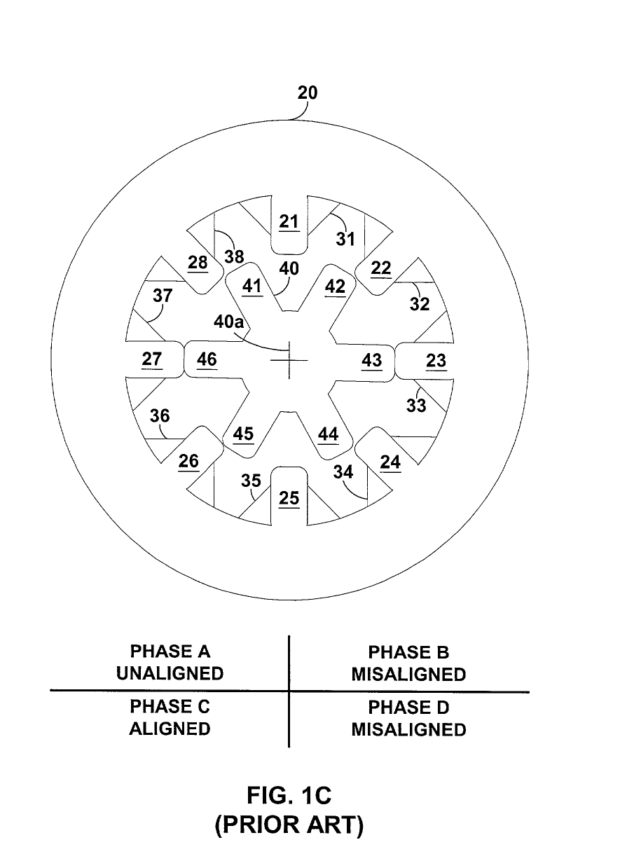

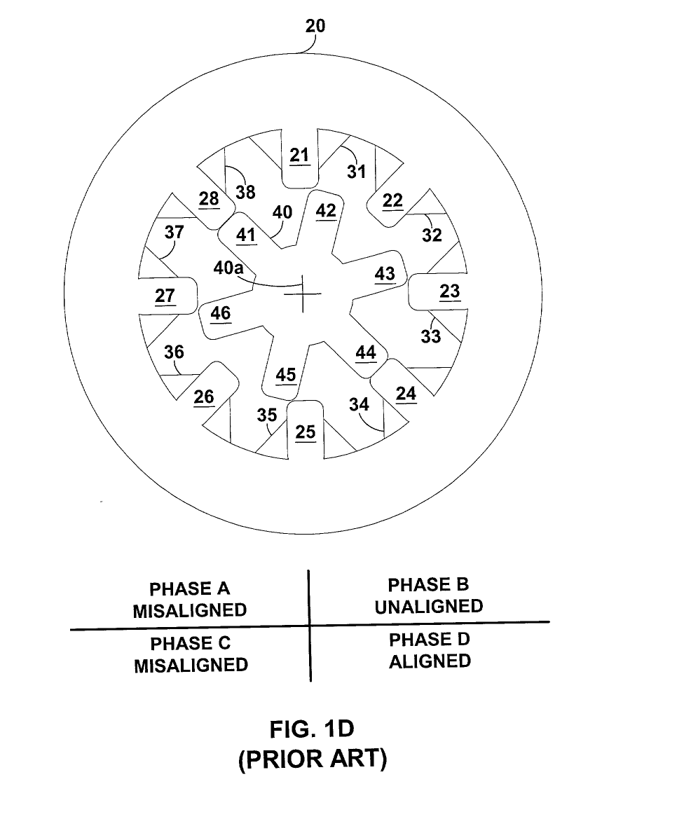

Switched-reluctance motor interface 54 receives commutation control signal CCₛ from controller 51. In response thereto, switched-reluctance motor interface 54 is designed to conventionally commutate, separately or concurrently, one or more phases A-D of windings 31-38 to thereby control a rotation of rotor 40 (FIG. 1) about axis 40a (FIG. 1). Specifically, interface 54 provides a phase current signal I_{PS1} as commanded by commutation control signal CCₛ through winding 31 and winding 35, a phase current signal I_{PS2} as commanded by commutation control signal CCₛ through winding 32 and winding 36, a phase current signal I_{PS3} as commanded by commutation control signal CCₛ through winding 33 and winding 37, and a phase current signal I_{PS4} as commanded by commutation control signal CCₛ through winding 34 and winding 38. Those having ordinary skill in the art will appreciate the various embodiments of interface 54 as known in the art, such as, for example, an arrangement of switches in the form of MOSFET transistors.

When rotor position sensor 55 is included within control device 50, rotor position sensor 55 conventionally provides a position detection signal PDs to controller 51. Position detection signal PDs is indicative of a sensed rotational position of rotor 40 (FIG. 1) whereby controller 51 can conventionally estimate the position of rotor 40. Those having ordinary skill in the art will appreciate the various embodiments of rotor position sensor 55 as known in the art, such as, for example, an arrangement of Hall Effect sensors, encoders, and the like. Alternatively, when rotor position sensor 55 is excluded from control device 50, interface 54 implements algorithms known in the art to estimate the position of rotor 40 as a function of phase currents I_{PS1-PS4}.

Referring additionally to FIG. 3, routine 60 comprises a pre-alignment stage S62, a preliminary stage S64 and a primary stage S66. Routine 60 is described herein in conjunction with the 4-phase 8 stator pole/6 rotor pole switched-reluctance motor shown in FIGS. 1A-1D. Those having ordinary skill in the art however will appreciate the applicability of routine 60 to other types of switched-reluctance motors.

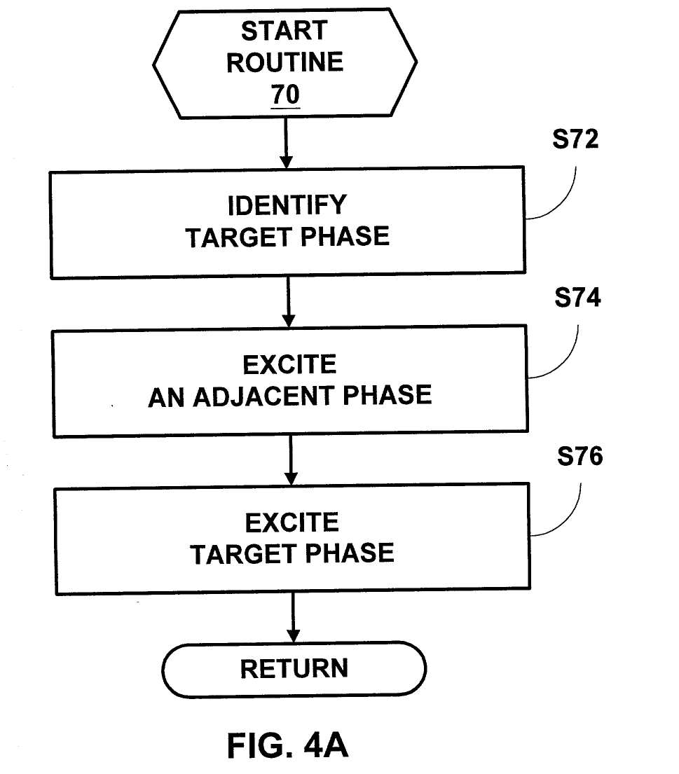

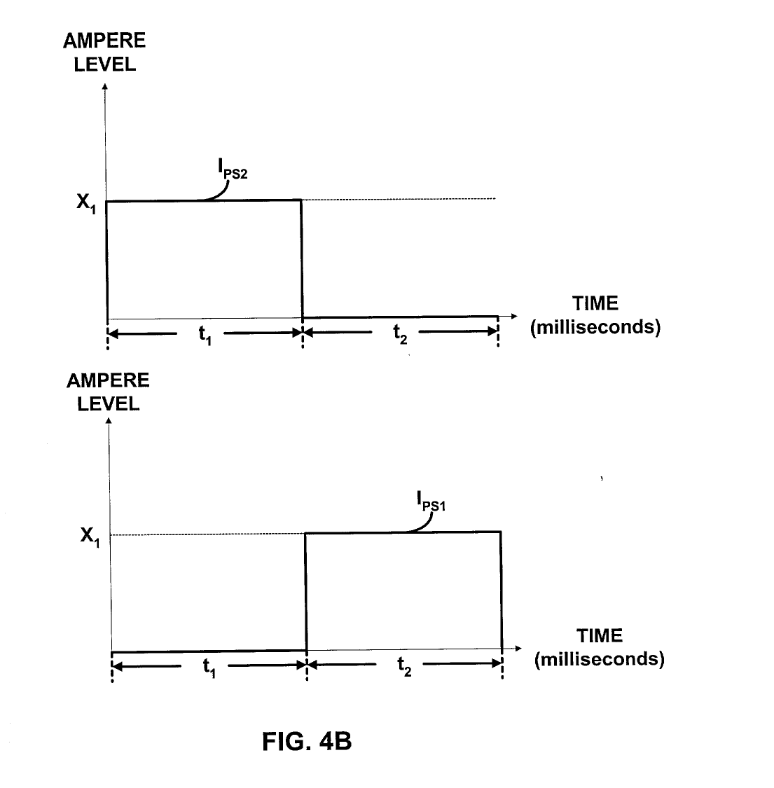

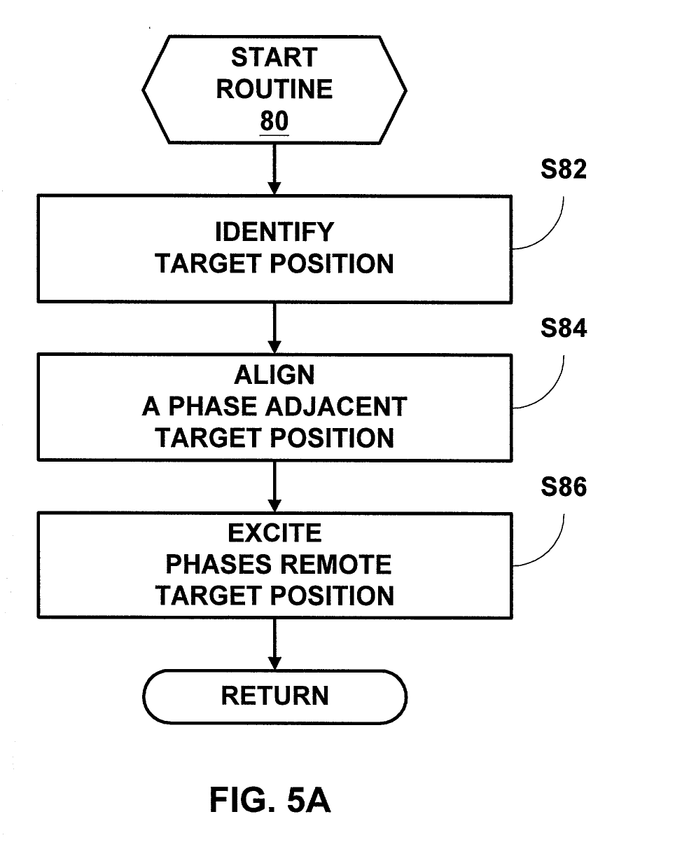

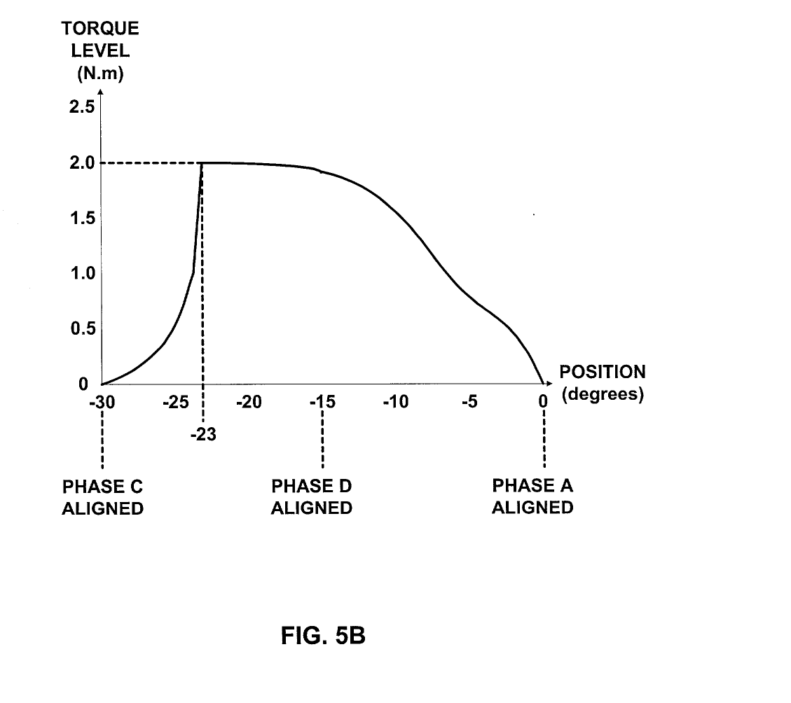

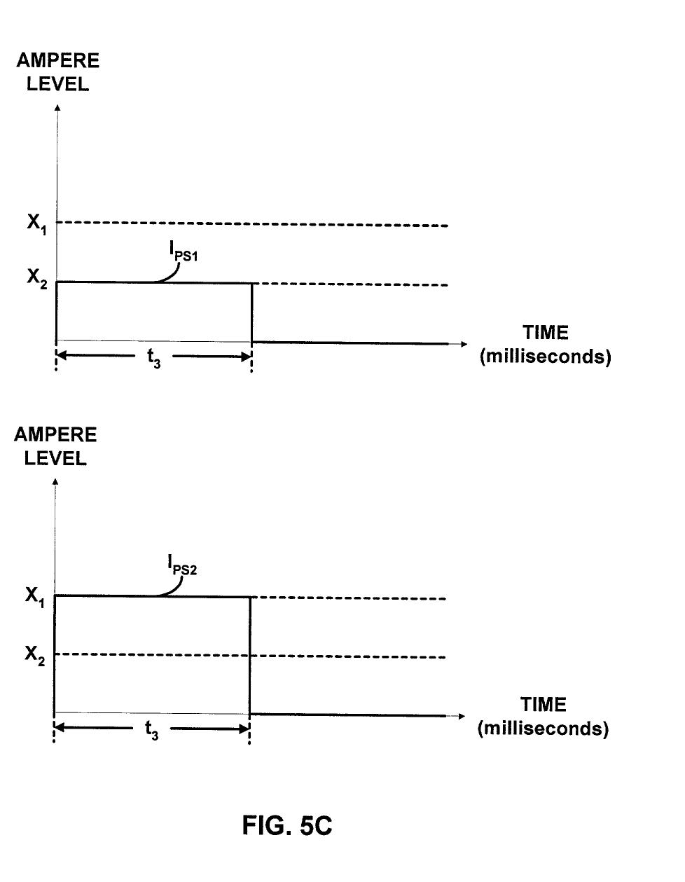

During stage S62, controller 51 executes a pre-alignment routine 70 as shown in FIG. 4A in one embodiment of routine 60 and a pre-alignment routine 80 as shown in FIG. 5A in another embodiment of routine 60. Routines 70 and 80 are for aligning one of the rotor poles 41-46 (FIG. 1) with one of the stator poles 21-28 (FIG. 1) in response to an actuation command AC from a device (e.g., a brake-by-wire controller) (not shown) of a system housing control device 50.

Referring to FIGS. 1A-1D, 4A, and 4B, during a stage S72 of routine 70, controller 51 identifies a target phase for defining an initial position of rotor 40. In one embodiment, the identification of the target phase is retrieved from memory 53. For example, microprocessor 52 can retrieve from memory 53 the identification of phase A (FIG. 1A) as the target phase.

During a stage S74 of routine 70, controller 51 controls an excitement of a phase adjacent to the target phase to thereby position rotor 40 whereby the target phase is misaligned. The excitation is accomplished by controller 51 directing interface 54 via commutation control signal CCₛ to provide a corresponding phase current to the corresponding windings. For example, when phase A is the target phase, phase A may be aligned (i.e., a pair of rotor poles being aligned with stator pole 21 and stator pole 25) as shown in FIG. 1A; phase A may be unaligned (i.e., a pair of rotor poles being equidistant from stator pole 21 and another pair of rotor poles being equidistant from stator pole 25) as shown in FIG. 1C; or phase A may be misaligned (i.e., neither aligned or unaligned) as shown in FIGS. 1B and 1D. Interface 54 directs a flow of a phase current I_{PS2} at an ampere level X₁ through winding 32 and winding 36 for a time period t₁ as shown in FIG. 4B to thereby rotate rotor 40 to a position whereby phase B is aligned (i.e., a pair of rotor poles being aligned with stator pole 22 and stator pole 26) as shown in FIG. 1B; or phase B is unaligned position (i.e., a pair of rotor poles being equidistant from stator pole 22 and another pair of rotor poles being equidistant from stator pole 26) as shown in FIG. 1D. As a result, phase A is misaligned as shown in FIG. 1B or FIG. 1D.

During a stage S76 of routine 70, controller 51 controls an excitement of the target phase to thereby position rotor 40 whereby the target phase aligned. The excitation is accomplished by controller 51 directing interface 54 via commutation control signal CCₛ to provide a corresponding phase current to the corresponding windings. For example, when phase A is the target phase, interface 54 directs a flow of a phase current I_{PS1} at ampere level X₁ through winding 31 and winding 35 for a time period t₂ as shown in FIG. 4B to thereby rotate rotor 40 to a position whereby phase A is aligned as shown in FIG. 1A.

Controller 51 returns to routine 60 upon completion of stage S76. Those having ordinary skill in the art will appreciate that a benefit of routine 70 is the capability of controller 51 to subsequently control a cranking of rotor 40 in a desired direction. Referring to FIGS. 1A-1D, and 5A-5C, during a stage S82 of routine 80, controller 51 identifies a target position for defining an initial position of rotor 40. In one embodiment of stage S82, the target position is selected as a function of maximizing the torque level experienced by an actuating member (e.g., a planetary gear system) being coupled to rotor 40 when rotor 40 is in the initial position, and the identification of the target position is retrieved from memory 52 by microprocessor 51. For example, as shown in FIG. 5B, a simulated rotation of rotor 40 can indicate a position of −23 from an alignment of phase A that provides the maximum torque level to the actuating member, and a rotation of rotor 40 from the −23 position of phase A aligned in a counterclockwise direction facilitates a minimum response time by rotor 40. Accordingly, the −23 position of phase A aligned is stored in memory 53 as the target position.

During a stage S84 of routine 80, controller 51 controls an alignment of a phase adjacent the target position. In one embodiment of stage S84, controller 51 implements routine 70 during stage S84 as previously described herein. For example, phase D is adjacent the −23 position of phase A aligned and interface 54 therefore directs a flow of phase current I_{PS3} through winding 33 and winding 37 during stage S74 to thereby rotate rotor 40 to a position whereby phase D is misaligned as shown in FIG. 1A or in FIG. 1C. Interface 54 thereafter directs a flow of phase current I_{PS4} through winding 34 and winding 38 during stage S76 to thereby rotate rotor 40 to a position whereby phase D is aligned as shown in FIG. 1D.

During a stage S86 of routine 80, controller 51 controls an excitement of two or more phases remote from the target position. The excitation is accomplished by controller 51 directing interface 54 via commutation control signal CCₛ to provide corresponding phase currents to the corresponding windings with a differential ampere level between the phase currents of the remote phases. For example, phase A and phase B are the phases that are remote the −23 position of phase A aligned and interface 54 therefore directs a flow of phase current I_{PS1} through winding 31 and winding 35 at an ampere level X₂ for a time period t₃ and a flow of phase current I_{PS2} winding 32 and winding 36 at ampere level X₁ for time period t₃ to thereby rotate rotor 40 to the −23 position of phase A aligned as shown in FIG. 5B.

In an alternative embodiment of stage S86, controller 51 utilizes the position detection signal P_{DS} from sensor 55 during stage S84 and stage S86 to direct interface 54 via commutation control signal CCₛ to provide the appropriate phase current(s) whereby rotor 40 is rotated to the −23 position of phase A aligned as shown in FIG. 5B.

Controller 51 returns to routine 60 upon completion of stage S86. Those having ordinary skill in the art will appreciate that benefit of routine 80 is the capability of controller 51 to subsequently control a cranking of rotor 40 in a desired direction within a minimized response time.

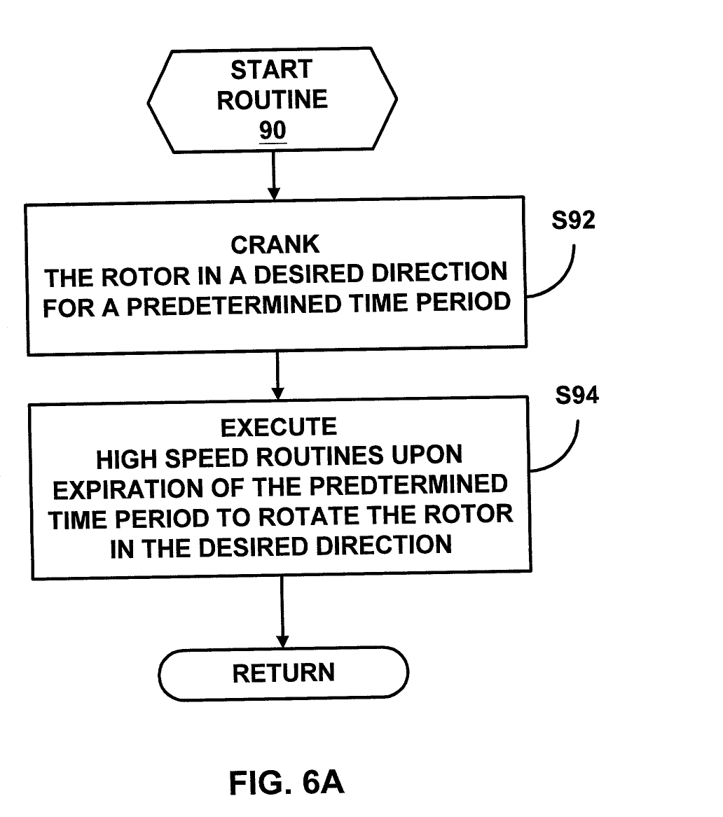

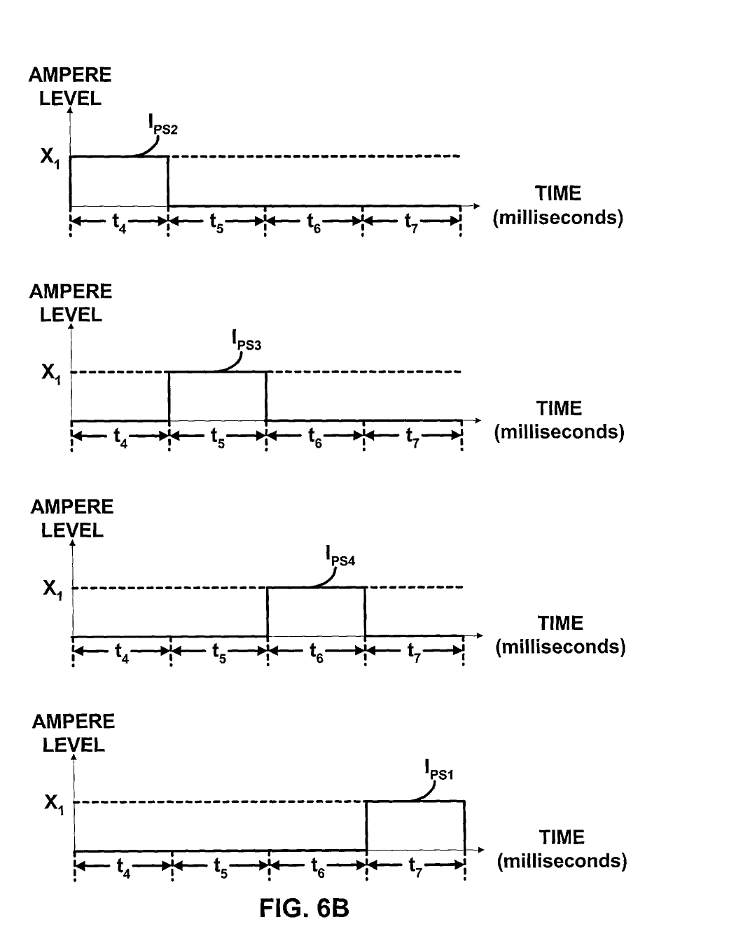

Referring to FIGS. 2 and 3, controller 51 proceeds to stage S64 of routine 60 upon a completion of stage S62. During stage S64, controller 51 executes a preliminary control routine 90 as shown in FIG. 6A.

Referring to FIGS. 1A-1D, 6A and 6B, during a stage S92 of routine 90, controller 51 cranks rotor 40 in a desired direction for a predetermined time period. In one embodiment of stage S92, controller 51 controls a sequential excitement of phases for one or more cycles to thereby crank rotor 40 in a desired direction (e.g., in a direction of a holding position corresponding to a predetermined range of rotation from the initial position) as dictated by the actuation command AC. The sequential excitation is accomplished by controller 51 directing interface 54 via commutation control signal CCₛ to sequentially provide corresponding phase currents to the corresponding windings for one or more cycles. For example, as shown in FIG. 6B, when phase A aligned represents the initial position of rotor 40 and the holding position is in a counterclockwise direction therefrom, interface 54 directs a flow of phase current I_{PS2} through winding 32 and winding 36 for a time period t₄ to thereby excite phase D whereby rotor 40 rotates in a counterclockwise direction. Interface 54 then directs a flow of phase current I_{PS3} through winding 33 and winding 37 for a time period t₅ to thereby excite phase C whereby rotor 40 continues to rotate in a counterclockwise direction. Interface 54 then directs a flow of phase current I_{PS4} through winding 34 and winding 38 for a time period t₆ to thereby excite phase B whereby rotor 40 continues to rotate in a counterclockwise direction. Interface 54 then directs a flow of phase current I_{PS1} through winding 31 and winding 35 for a time period t₇ to thereby excite phase A whereby rotor 40 continues to rotate in a counterclockwise direction. The sequential excitation of one or more phases B-C-D-A can be repeated as needed for rotor 40 to crank rotor 40 in the desired direction (e.g., a direction of a holding position).

In one embodiment of stage S92, each time period t₄₋₇ is fixed at a particular level (e.g., 2 milliseconds). In a second embodiment of stage S92, each time period t₄₋₇ is fixed at one or more various levels (e.g., t₄ being 2 milliseconds, t₅ being 1.8 milliseconds, t₆ being 1.6 milliseconds, and t₇ being 1.4 milliseconds). In a third embodiment of stage S92, controller 51 dynamically determines the levels of time periods t₄₋₇ as a function of operating parameters of the motor as would occur to those having ordinary skill in the art, such as, for example, any load torque applied by the motor, a power supply for the motor, a temperature of the motor, and a responsiveness level of the motor to the phase currents I_{PS1-PS4}.

Upon expiration of the predetermined time period during stage S92, controller 51 proceeds to stage S94 of routine 90 to execute high speed routines as well known in the art whereby rotor 40 is rotated in the desired direction. Controller 51 terminates routine 90 upon completion of stage S94. In one embodiment of stage S94, rotor 40 is rotated until rotor 40 is positioned in a holding position.

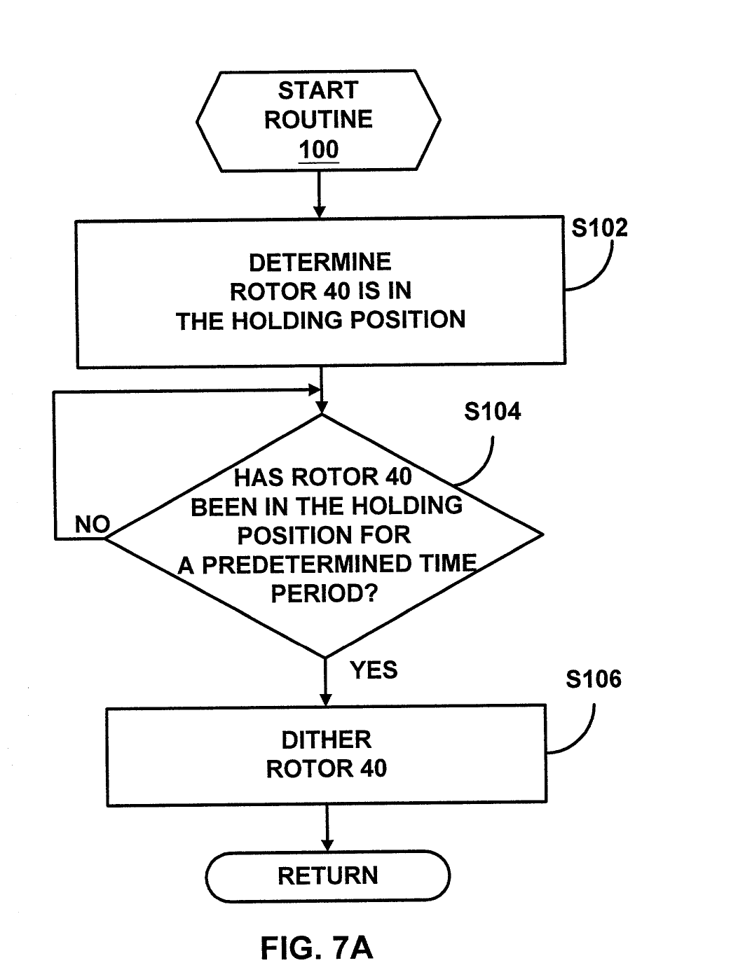

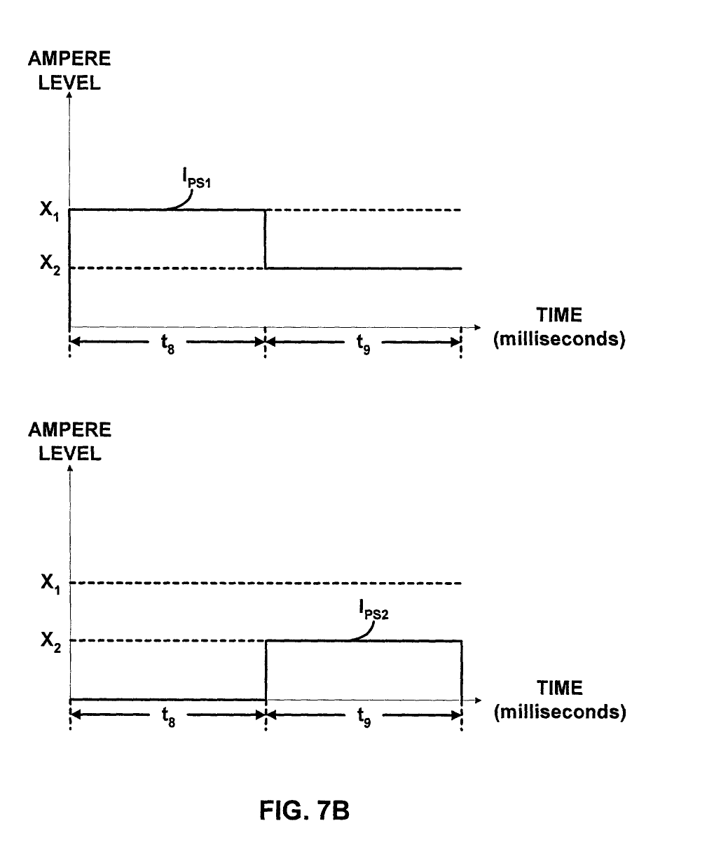

Referring to FIGS. 2 and 3, controller 51 proceeds to stage S66 of routine 60 to execute a primary control routine 100 as shown in FIG. 7A and a primary control routine 110 as shown in FIG. 5A. Routines 100 and 110 are for minimizing any heating losses and any current losses, respectively, of the switched-reluctance motor when rotor 40 is positioned in the holding position.

Referring to FIGS. 1A-1D, 2, 7A and 7B, during a stage S102 of routine 100, controller 51 determines if rotor 40 is in the holding position. In one embodiment of stage S102, controller 51 determines rotor 40 is in the holding position when a load force signal LFs indicates an actual load force on the actuating member approximates a desired load force on the actuating member that corresponds to the holding position as indicated by the actuation command AC. Load force signal LFs is provided to controller 51 by sensors known in the art.

Controller 51 proceeds to a stage S104 of routine 100 when controller 51 determines if rotor 40 is in the holding position during stage S102. During stage S104, controller 51 determines if rotor 40 has been in the holding position for a predetermined time period. In one embodiment of stage S104, interface 54 includes an arrangement of switches and either controller 51 or interface 54 includes a counter. The counter is utilized to count the time a particular switch corresponding to the holding position is turned on. When controller 51 determines rotor 40 has been in the holding position for a predetermined time period, controller 51 proceeds to a stage S106 of routine 100 to control a dithering of rotor 40.

In one embodiment of stage S106, controller 51 directs interface 54 to sequentially excite phases adjacent the holding position for one or more time cycles. The sequential excitation is accomplished by controller 51 directing interface 54 via commutation control signal CCₛ to sequentially provide corresponding phase currents to the corresponding windings for one or more cycles. For example, when the holding position corresponds to phase A aligned as shown in FIG. 1A and rotor 40 was rotated in a counterclockwise direction to the holding position, interface 54 directs a flow of phase current I_{PS4} through winding 34 and winding 38 for a predetermined time period to thereby excite phase D whereby rotor 40 is rotated in a clockwise direction. Interface 54 then directs a flow of phase current I_{PS1} through winding 31 and winding 32 for a predetermined time period to thereby again excite phase A whereby rotor 40 is rotated back to the holding position in a counterclockwise direction. The cycle of sequentially exciting phases D-A can be repeated as needed. In a second embodiment of stage S105, one or more cycles of sequentially exciting D-C-D-A is repeated as needed. In a third embodiment of stage S106, one or more cycles of sequentially exciting D-C-B-C-D-A is repeated as needed.

In a fourth embodiment of stage S106, controller 51 controls a decrease in excitation of a phase corresponding to the holding position while maintaining a motor torque level corresponding to the holding position. This is accomplished by controller 51 directing interface 54 via commutation control signal CCₛ to decrease the ampere level of the phase current corresponding to the excited phase and to initiate the flow of a phase current through an adjacent phase at an ampere level that will maintain the motor torque level. The motor torque level is a function of the design of the switched-reluctance motor, and controller 51 can therefore determine the motor torque level from a lookup table stored within memory 53.

For example, as shown in FIG. 7B, when the holding position corresponds to phase A aligned as shown in FIG. 1A and rotor 40 was rotated in a counterclockwise direction to the holding position, interface 54 directs a flow of phase current I_{PS1} through winding 31 and winding 35 at an ampere level X₁ for a time period t₈ to excite phase A. Subsequently, interface 54 directs a flow of phase current I_{PS1} through winding 31 and winding 35 at an ampere level X₂ that is lower than ampere level X₁ during a time period t₉. Concurrently during time period t₉, interface 54 directs a flow of phase current I_{PS2} through winding 32 and winding 34 at ampere level X₂ to thereby simultaneously excite phase A and phase B.

A fifth embodiment of stage S106 involves a modification of the fourth embodiment of stage S106 whereby the motor torque level as retrieved from memory 53 is undulated about a fixed level after a fixed period of time. The ampere levels of phase currents being supplied to the two phases are adjusted accordingly as appreciated by those having ordinary skill in the art.

Controller 51 returns to routine 60 upon completion of stage S106. Those having ordinary skill in the art will appreciate that benefit of routine 100 is the capability of controller 51 to prevent local overheating of stator 20, windings 31-38, and rotor 40. As a result, stress within windings 31-38 and an uneven resistance variation of the phases are minimized.

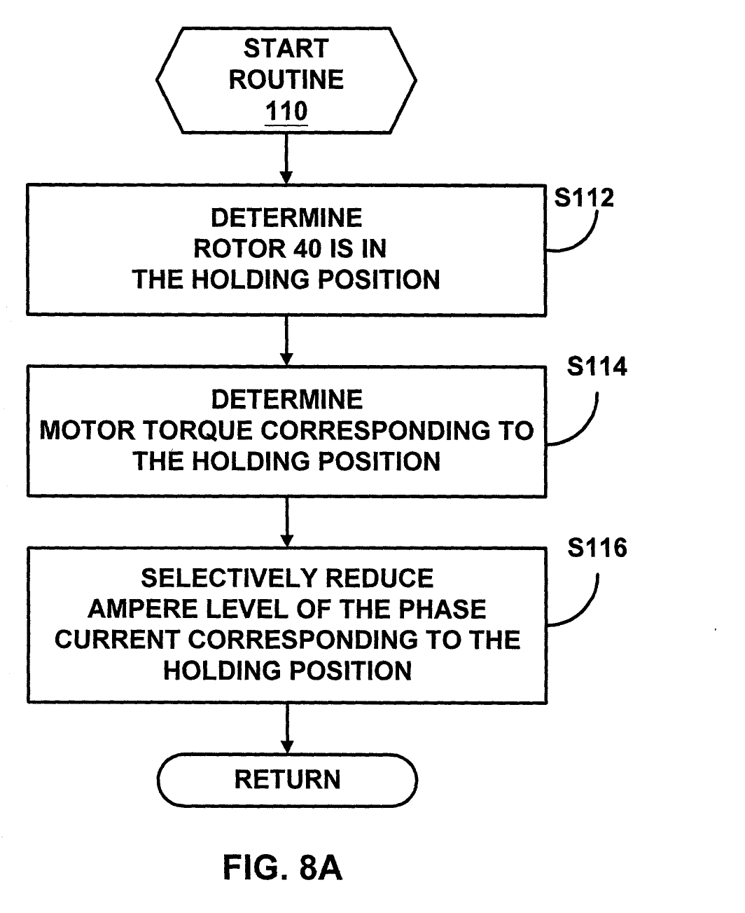

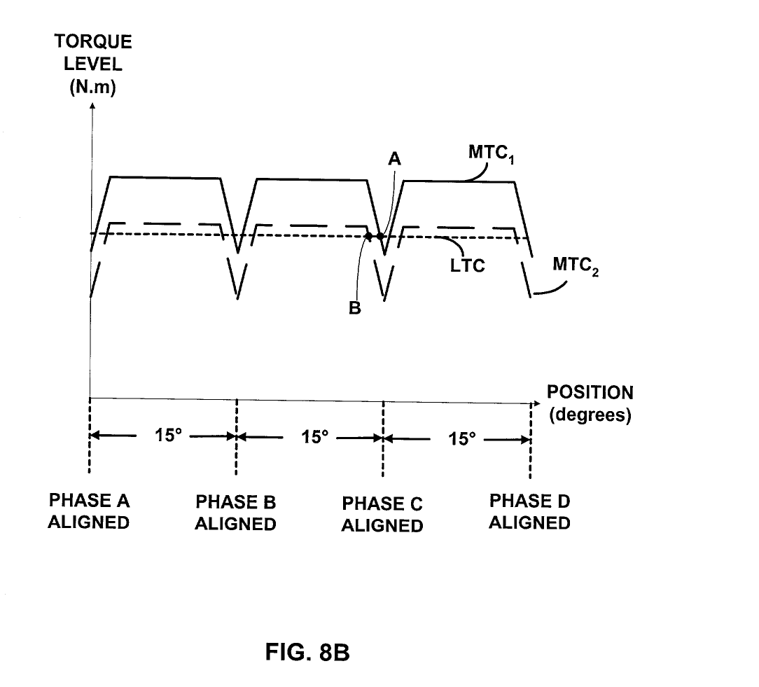

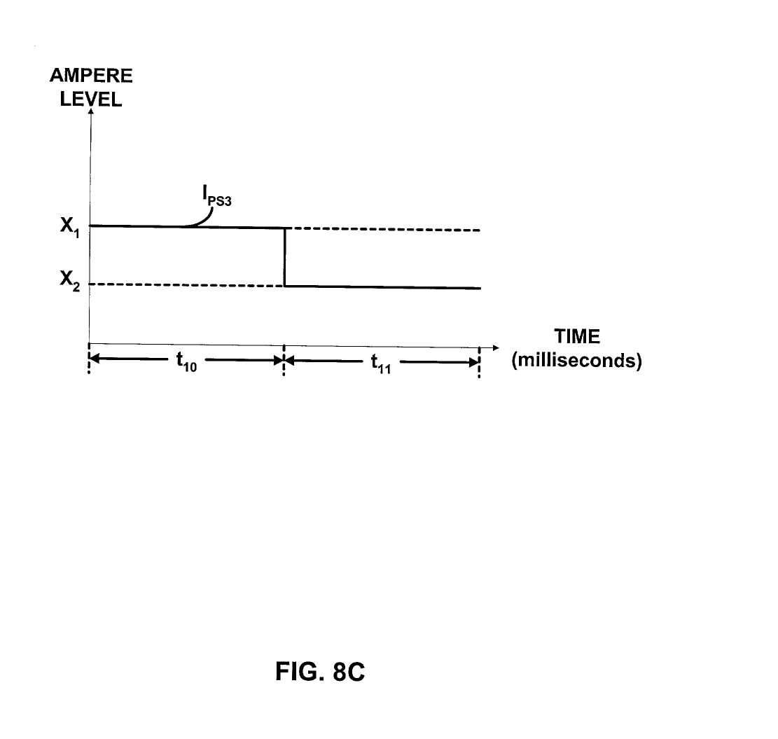

Referring to FIGS. 1A-1D, 2, and 8A-8C, during a stage S112 of routine 110, controller 51 determines the holding position of rotor 40 as previously described herein in connection with stage S102 (FIG. 7A). During a stage S114 of routine 110, controller 51 determines a motor torque corresponding to the holding position of rotor 40. In one embodiment, controller 51 retrieves the motor torque from a lookup table in memory 53. For example, as shown in FIG. 8B, controller 51 can retrieve a motor torque level corresponding to an intersection of a holding position A corresponding to phase C aligned (FIG. 1C) and a motor torque curve MTC₁.

During a stage S116 of routine 110, controller 51 controls a reduction of an ampere level of a phase current corresponding to the holding position of rotor 40. The reduction in ampere level is accomplished by controller 51 directing interface 54 via commutation control signal CCₛ to reduce the ampere level of the excited phase current. In one embodiment of stage S116, the adjustment of the ampere level maintains a motor torque level that is greater than the load torque being applied to the actuating member coupled to rotor 40.

For example, as shown in FIG. 8C, when phase C aligned corresponds to the holding position, interface 54 directs a flow of phase current I_{PS3} at an ampere level X₁ through winding 33 and winding 37 for time period t₁₀ to maintain rotor 40 in the holding position. Thereafter, interface 54 then directs a flow of phase current I_{PS3} at an ampere level X₂ through winding 37 and winding 37 for time period t₁₁ to thereby establish a level of motor torque corresponding to an intersection of a position B of rotor 40 and a motor torque curve MTC₂ as shown in FIG. 8B while maintaining rotor 40 in the holding position.

Controller 51 returns to routine 110 upon completion of stage S116. Those having ordinary skill in the art will appreciate that a benefit of routine 110 is a minimization of current while maintaining rotor 40 in a holding position.

Referring again to FIG. 3, routine 60 as described herein is intended to be utilized in systems requiring pre-alignment stage S62, preliminary stage S64 and primary stage S66, such as, for example, an electric caliper brake system. Nevertheless, one of the stages S62-S66 of routine 60 can be individually implemented within a system, and two of the stages S62-S66 of routine 60 can be jointly implemented within a system. Also, any embodiments of the various embodiments of stages S62-S66 such as routine 70 (FIG. 4A), routine 80 (FIG. 5A), routine 90 (FIG. 6A), routine 100 (FIG. 7A) and routine 110 (FIG. 8A) can be individually or jointly implemented within systems.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method of controlling an operation of a switched-reluctance motor including a stator having a stator pole and a rotor having a rotor pole, said method comprising the steps of:
aligning the rotor pole and the stator pole in response to a reception of an actuation command; and
cranking the rotor in a direction as dictated by the actuation command for a predetermined time period.

2. The method of claim 1, further comprising:
rotating the rotor to a holding position upon an expiration of the predetermined time period.

3. The method of claim 2, further comprising:
minimizing any current losses of the switched-reluctance motor when the rotor is in the holding position.

4. The method of claim 2, further comprising:
minimizing any heating losses of the switched-reluctance motor when the rotor is in the holding position.

5. A method for controlling an alignment of a stator pole and a rotor pole of a switched-reluctance motor, said method comprising:
identifying a first phase of the motor as a target phase defining an initial position of the rotor pole that corresponds to the alignment of the stator pole and the rotor pole;
exciting a second phase of the motor, the second phase adjacent the first phase; and
subsequently exciting the first phase of the motor.

6. A method for controlling an alignment of a rotor pole of a switched-reluctance motor to a target position, said method comprising:
identifying the target position;
aligning a phase of the motor adjacent the target position; and
subsequently and concurrently exciting a second phase of the motor and a third phase of the motor, the second phase and the third phase being remote from the target position.

7. A method for controlling a rotation of a rotor of a switched-reluctance motor in a desired direction, said method comprising:
sequentially exciting a plurality of phases of the switched-reluctance motor for one or more cycles whereby the rotor is cranked to rotate in the desired direction; and
rotating the rotor in the desired direction upon an expiration of the one or more cycles.

8. A method for controlling a minimization of any heat losses by a switched-reluctance motor having a rotor in a holding position, said method comprising:
determining the rotor is in the holding position; and
dithering the rotor upon the rotor being in the holding position for a predetermined time period.

9. A method for controlling a minimization of any current losses by a switched-reluctance motor having a rotor in a holding position, said method comprising:
determining a motor torque corresponding to the holding position; and
selectively reducing an ampere level of a phase current corresponding to the holding position.

10. A device for controlling an operation a switched-reluctance motor including a stator having a stator pole and a rotor having a rotor pole, said device comprising:
means for aligning the rotor pole and the stator pole in response to a reception of an actuation command; and
means for cranking the rotor in a direction as dictated by the actuation command for a predetermined time period.

11. The device of claim 10, further comprising:
means for rotating the rotor to a holding position upon an expiration of the predetermined time period.

12. The device of claim 11, further comprising:
means for minimizing any current losses of the switched-reluctance motor when the rotor is in the holding position.

13. The device of claim 11, further comprising:
means for minimizing any heating losses of the switched-reluctance motor when the rotor is in the holding position.

14. A device for controlling an alignment of a stator pole and a rotor pole of a switched-reluctance motor, said device comprising:
means for identifying a first phase of the motor as a target phase defining an initial position of the rotor pole that corresponds to the alignment of the stator pole and the rotor pole;
means for exciting a second phase of the motor, the second phase adjacent the first phase; and
means for subsequently exciting the first phase of the motor.

15. A device for controlling an alignment of a rotor pole of a switched-reluctance motor to a target position, said device comprising:
means for identifying the target position;
means for aligning a phase of the motor adjacent the target position; and
means subsequently and concurrently exciting a second phase of the motor and a third phase of the motor, the second phase and the third phase being remote from the target position.

16. A device for controlling a rotation of a rotor of a switched-reluctance motor in a desired direction, said device comprising:
means for sequentially exciting a plurality of phases of the switched-reluctance motor for one or more cycles whereby the rotor is cranked to rotate in the desired direction; and
means for rotating the rotor to the holding position upon an expiration of the one or more cycles.

17. A device for controlling a minimization of any heat losses by a switched-reluctance motor having a rotor in a holding position, said device comprising:
means for determining the rotor is in the holding position; and
means for dithering the rotor upon the rotor being in the holding position for a predetermined time period.

18. A device for controlling a minimization of any current losses by a switched-reluctance motor having a rotor in a holding position, said device comprising:
means for determining a motor torque corresponding to the holding position; and
means for selectively reducing an ampere level of a phase current corresponding to the holding position.

19. A system, comprising:
a switched-reluctance motor including
a stator having a stator pole, and
a rotor having a rotor pole;
means for aligning the rotor pole and the stator pole in response to a reception of an actuation command; and
means for cranking the rotor in a direction as dictated by the actuation command for a predetermined time period.

20. The system of claim 19, further comprising:
means for rotating the rotor to a holding position upon an expiration of the predetermined time period.

21. The system of claim 20, further comprising:
means for minimizing any current losses of the switched-reluctance motor when the rotor is in the holding position.

22. The system of claim 20, further comprising:
means for minimizing any heating losses of the switched-reluctance motor when the rotor is in the holding position.

23. A system, comprising:
a switched-reluctance motor including
a stator having a stator pole, and
a rotor having a rotor pole;
means for identifying a first phase of the motor as a target phase defining an initial position of the rotor pole that corresponds to the alignment of the stator pole and the rotor pole;
means for exciting a second phase of the motor, the second phase adjacent the first phase; and
means for subsequently exciting the first phase of the motor.

24. A system, comprising:
a switched-reluctance motor including a rotor having a rotor pole;
means for identifying a target position of said rotor pole;
means for aligning a phase of the motor adjacent the target position; and
means for subsequently and concurrently exciting a second phase of the motor and a third phase of the motor, the second phase and the third phase being remote from the target position.

25. A system, comprising:
a switched-reluctance motor including a rotor;
means for sequentially exciting a plurality of phases of the switched-reluctance motor for one or more cycles whereby the rotor is cranked to rotate in the desired direction; and
means for rotating the rotor to the holding position upon an expiration of the one or more cycles.

26. A system, comprising:
a switched-reluctance motor including a rotor operable to be rotated to a holding position;
means for determining the rotor is in the holding position; and
means for dithering the rotor upon the rotor being in the holding position for a predetermined time period.

27. A system, comprising:
a switched-reluctance motor including a rotor operable to be rotated to a holding position;
means for determining a motor torque corresponding to the holding position; and
means for selectively reducing an ampere level of a phase current corresponding to the holding position.
